(19) United States
(12) Patent Application Publication
(10) Pub. No.: US 2016/0157157 A1
(43) Pub. Date: Jun. 2, 2016

(54) WIRELESS TRANSMISSION SYSTEM

(71) Applicant: GEMTEK TECHNOLOGY CO., LTD., Hsinchu (TW)

(72) Inventors: CORY KOON-SING LAM, HSINCHU (TW); CHUN-CHUNG LIN, HSINCHU (TW)

(21) Appl. No.: 14/753,147

(22) Filed: Jun. 29, 2015

Related U.S. Application Data
(60) Provisional application No. 62/085,761, filed on Dec. 1, 2014.

(51) Int. Cl. H04W 40/22; H04B 7/155

(52) U.S. Cl. CPC H04W 40/22; H04B 7/15507

(57) ABSTRACT

The present invention relates to a wireless transmission system, which comprises at least an electronic device, a repeater, and a transceiver. The electronic device transmits a signal to the transceiver and the repeater. The repeater transmits the received signal to the transceiver. Thereby, when the transceiver is unable to receive the signal from the electronic device correctly due to the communication blind spot, the transceiver still can receive the signal of the electronic device via the repeater.

### FIELD OF THE INVENTION

The present invention relates generally to a transmission system, and particularly to a wireless transmission system applied in an environment including communication blind spots and thus improving the transmission quality.

### BACKGROUND OF THE INVENTION

As technologies are developed and networks are popularized, networks are extensively applied to the electronic devices in various fields and in daily lives for receiving external signals or transmitting signals to other electronic devices. Most of this type of transmission and receiving of signals adopt wireless transmission.

Nonetheless, the wireless electromagnetic waves adopted by wireless transmission technologies cannot penetrate thicker objects. In modern cities having tall buildings and great mansions or remote districts with more obstructions, wireless electromagnetic waves are obstructed by more obstructions, disabling receiving of the wireless electromagnetic waves in some regions. These regions incapable of receiving electromagnetic waves are called communication blind spots. Communication blind spots are unpredictable by users. For example, at a prior moment, a user is located in an area without obstructions, enabling him to use the wireless transmission functions of an electronic device. Unfortunately, if he moves a step forward, he enter a communication blind spot, interrupting the ongoing wireless transmission function and stopping the electronic device from uploading/downloading information unless he leaves the communication blind spot and reconstructs the connection. This brings inconvenience to users and affects the stability of wireless transmission.

As shown in FIG. 1, according to the prior art, when an electronic device 10 is situated in an environment having an obstruction 90 and about to transmit a wireless signal to the transceiver 90, the wireless signal transmitted by the electronic device 10 cannot be transmitted to the transceiver 50 because the wireless signal is unable to penetrate the obstruction 90.

Accordingly, how to enable an electronic device to transmit and receive wireless signals in an environment with communication blind spots has become an important issue presently.

### SUMMARY

An objective of the present invention to provide a wireless transmission system, which enables an electronic device to transmit and receive wireless signal with certainty even in an environment with communication blind spots.

Another objective of the present invention to provide a wireless transmission system, which is applied to a surveillance system and enables the sensing signals of the surveillance system to be transmitted to a transceiver with certainty for monitoring the field condition.

Still another objective of the present invention to provide a wireless transmission system, which is applied to rescuing. Thereby, the victims can transmit signals with certainty using their electronic devices to the transceivers of the rescue unit for rescuing.

The wireless transmission system according to an embodiment of the present invention comprises at least an electronic device, a repeater, and a transceiver. The electronic device transmits a first wireless signal. The repeater includes a plurality of receiving channels and a transmitting/receiving channel. The plurality of receiving channels receives the first wireless signal. The transmitting/receiving channel transmits the first wireless signal received by the repeater. The transceiver includes a plurality of receiving channels and a receiving/transmitting channel. The plurality of receiving channels of the transceiver are used for receiving the first wireless signal transmitted by the electronic device. The receiving/transmitting channel is used for receiving the first wireless signal transmitted by the transmitting/receiving channel of the repeater. Thereby, when the first wireless signal transmitted by the electronic device to the transceiver directly is obstructed, the transceiver can still receive the first wireless signal of the electronic device via the repeater.

### BRIEF DESCRIPTION OF THE DRAWINGS

FIG. 1 shows a schematic diagram of the wireless transmission system according to the prior art;

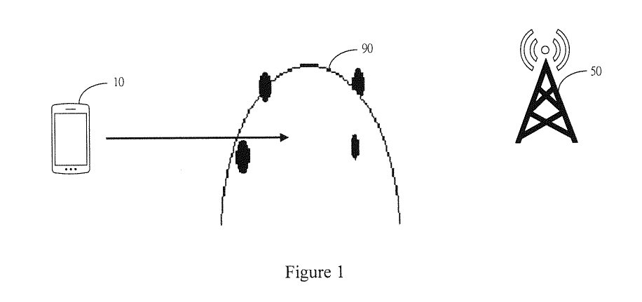

FIG. 2A shows an architecture diagram of the wireless transmission system according to the first embodiment of the present invention, representing the electronic device in the wireless transmission system transmitting a wireless signal to the transceiver;

FIG. 2B shows an architecture diagram of the wireless transmission system according the first embodiment of the present invention, representing the transceiver in the wireless transmission system transmitting a wireless signal to the electronic device;

FIG. 3 shows a block diagram of the wireless transmission system according to the present invention;

FIG. 4 shows an architecture diagram of the wireless transmission system according the second embodiment of the present invention; and

FIG. 5 shows an architecture diagram of the wireless transmission system according the third embodiment of the present invention.

### DETAILED DESCRIPTION

In order to make the structure and characteristics as well as the effectiveness of the present invention to be further understood and recognized, the detailed description of the present invention is provided as follows along with embodiments and accompanying figures.

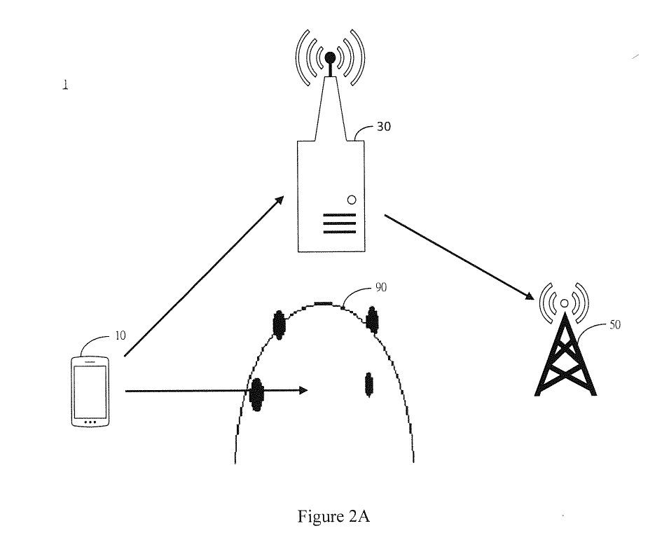

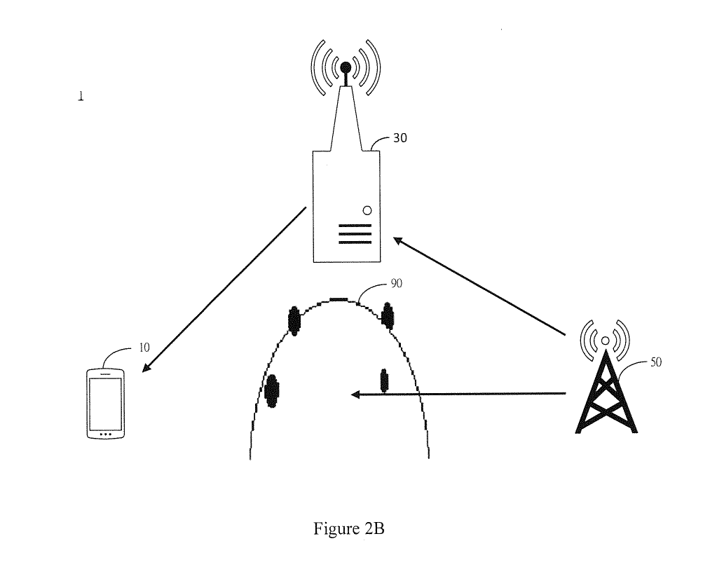

Please refer to FIG. 2. As shown in the figure, the present embodiment provides a wireless transmission system 1, which comprises at least an electronic device 10, a repeater 30, and a transceiver 50.

The first electronic device 10 according to the present embodiment may be a smartphone, a personal digital assistant (PDA), a tablet computer, a notebook computer, a desktop computer, a monitor, a sensor, or other electronic devices having transmission functions for wireless signals.

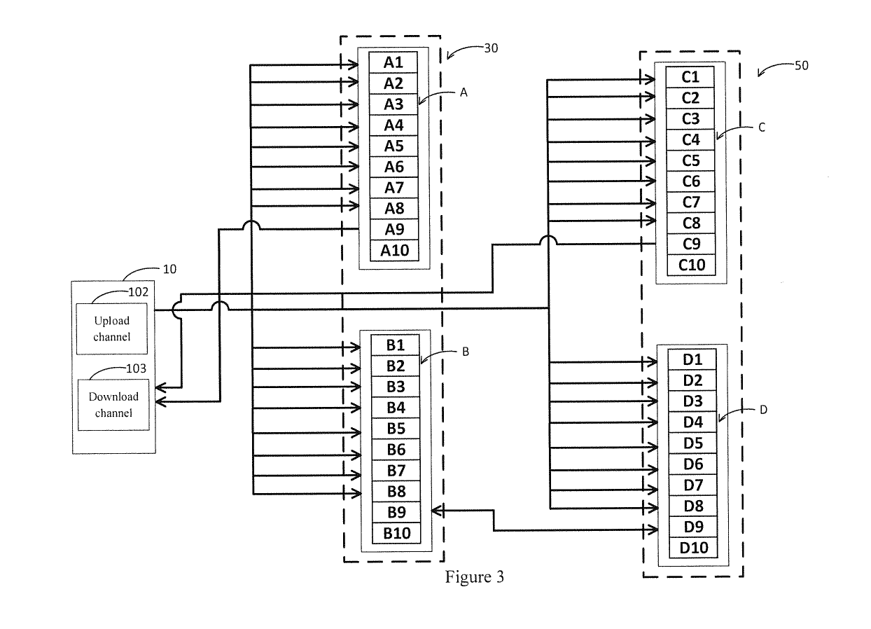

The repeater 30 according to the present embodiment includes a plurality of receiving channels (as the channels A1˜A8 and B1˜B8 shown in FIG. 3) and a transmitting/receiving channel (as the channel B9 shown in FIG. 3). The plurality of receiving channels can receive wireless signals. The transmitting/receiving channel transmits the wireless signals received by the repeater 30. The plurality of receiving channels can adopt the IEEE802.11a, the IEEE802.11b, the IMT2000, the CDMA2000, or other wireless communication protocols. The bandwidth of the transmitting/receiving channel is wider than that of the plurality of receiving channels. The repeater 30 may be implemented by a network router, a network replay, or portable electronic equipment according to the practical requirements.

The transceiver 50 according to the present embodiment includes a plurality of receiving channels (as the channels C1˜C8 and D1˜D8 shown in FIG. 3) and a receiving/transmitting channel (as the channel D9 shown in FIG. 3). The plurality of receiving channels can receive wireless signals. The receiving/transmitting channel transmits the wireless signals received by the repeater 30. The bandwidth of the receiving/transmitting channel of the transceiver 50 is wider than that of the plurality of receiving channels of the transceiver 50. The plurality of receiving channels can adopt the IEEE802.11a, the IEEE802.11b, the IMT2000, the CDMA2000, or other wireless communication protocols. The transceiver 50 may be implemented by abuse station, a gateway, an access point, or portable electronic equipment according to the practical requirements.

According to an embodiment of the present invention, the transmitting receiving frequencies of the transmitting/receiving channel of the repeater 30 and the receiving/transmitting channel of the transceiver 50 described above is below 1000 Hertz. The adopted protocol is the IEEE802.15.4g LoRa. The transmission distance of wireless signals is above 15 kilometers.

Please refer again to FIG. 2A. When the electronic device 10 of the wireless transmission system 1 transmits a wireless signal to the transceiver 50, the plurality of receiving channels of the repeater 30 will receive the wireless signal as well. Because the wireless signal cannot penetrate the obstruction 90, the wireless signal cannot be transmitted to the transceiver 50. When the plurality of receiving channels of the repeater 30 receive the wireless signal transmitted by the electronic device 10, the wireless signal is transmitted to the transceiver 50 through the transmitting/receiving channel. The receiving/transmitting channel of the transceiver 50 adopts the same communication protocol as the one adopted by the transmitting/receiving channel of the repeater 50. Thereby, the wireless signal transmitted by the transmitting/receiving channel of the repeater 30 will be received by the receiving/transmitting channel of the transceiver 50. Consequently, the transceiver 50 still can receive the wireless signal of the electronic device 10 via the repeater 30.

Please refer again to FIG. 2A. In case the size, thickness, height, or material of the obstruction 90 is not sufficient to form a communication blind spot in the wireless transmission system 1 or there is no obstruction 90 on the transmission path of the wireless transmission system 1. the transceiver 50 will receive the wireless signal transmitted by both the electronic device 10 and the repeater 30. Then the transceiver 50 will judge if the wireless signal transmitted by the electronic device 10 is erroneous. If an error occurs, the transceiver 50 will select the wireless signal transmitted by the repeater 30 for maintaining reliability of the wireless transmission system 1. The above errors in the wireless signal as described above might be generated while the wireless signal transmitted by the electronic device 10 penetrating the obstruction 90, due to energy attenuation during the transmission process, or as a result of other signal interference.

Please refer to FIG. 2B. The transceiver 50 further comprises a transmitting channel (as the channel A9 shown in FIG. 3). When the transmitting channel of the transceiver 50 transmits the wireless signal to the electronic device 10, the wireless signal will be transmitted through the transmitting channel. In addition, the wireless signal will be further transmitted to the transmitting/receiving channel of the repeater 30 through the receiving/transmitting channel. Then, a transmitting channel (as the channel C3 shown in FIG. 3) of the repeater 30 will transmit the wireless signal to the electronic device 10. If the wireless signal cannot penetrate the obstruction 90 and the wireless signal cannot be transmitted to the electronic device 10, the electronic device 10 can still receive the wireless signal of the transceiver 50 via the repeater 30.

Please refer to FIG. 3. As shown in the figure, the electronic device 10 according to the resent invention comprises an upload channel 102 and a download channel 103. The upload channel 102 is used for transmitting the wireless signal; the download channel 103 is used for receiving the wireless signal.

The repeater 30 described above comprises a first communication chip A and a second communication chip B. The first communication chip A comprises a plurality of receiving channels A1˜A8 and a transmitting channel A9. The second communication chip B comprises a plurality of receiving channels B1˜B8 and a transmitting/receiving channel B9.

The transceiver 50 described above comprises a first communication chip C and a second communication chip D. The first communication chip C comprises a plurality of receiving channels C1˜C8 and a transmitting channel C9. The second communication chip D comprises a plurality of receiving channels D1˜D8 and a receiving/transmitting channel D9.

The plurality of communication chips A, B, C, D as described above include a reserved channel A10, B10, C10, D10, respectively, for future configuration according to the requirements. The above embodiment is only an embodiment of the present invention, not intended to limit the repeater 30 to include the first communication chip A and the second communication chip B only and the transceiver 50 to include the first communication chip C and the second communication chip D. The repeater 30 according to the present invention can comprise a plurality of communication chips (two or more communication chips). The plurality of communication chips comprise a plurality of receiving channels, respectively. In addition, one of the plurality of communication chips further comprises the transmitting/receiving channel as described above. Likewise, the transceiver 50 according to the present invention can comprise a plurality of communication chips (two or more communication chips). The plurality of communication chips of the transceiver 50 comprise a plurality of receiving channels, respectively. In addition, one of the plurality of communication chips of the transceiver 50 further comprises the receiving/transmitting channel as described above. Moreover, one of the plurality of communication chips of the transceiver 50 further comprises the transmitting channel as described above.

Please refer again to FIG. 3. When the electronic device 10 transmits the wireless signal to the transceiver 50 via the upload channel 102, the transceiver 50 receives the wireless signal through one of the plurality of receiving channel C1˜C8 and D1˜D8. Besides, the repeater 30 receives the wireless signal through one of the plurality of receiving channels A1˜A8 and B1˜B8, and transmits the wireless signal to the receiving/transmitting channel D9 of the transceiver 50 via the transmitting/receiving channel B9. Thereby, when the wireless signal of the electronic device 10 may unable to be transmitted from the electronic device 10 to the transceiver 50 directly, the transceiver 50 still may receive the wireless signal of the electronic device 10 with certainty.

Please refer again to FIG. 3. When the transceiver 50 transmits a wireless signal to the download channel 103 of the electronic device through the transmitting channel C9, the receiving/transmitting channel D9 also transmits the wireless signal to the transmitting/receiving channel B9 of the repeater 30. The repeater 30 transmits the wireless signal received from the transmitting/receiving channel B9 to the download channel 103 of the electronic device 10 via the transmitting channel A9. Thereby, when the wireless signal of the transceiver 50 may unable to be transmitted from the transceiver 50 to the electronic device 10 directly, the electronic device 10 still may receive the wireless signal of the transceiver 50 with certainty. According to the above description, it is known that the transmitting/receiving channel B9 of the repeater 30 and the receiving/transmitting channel D9 of the transceiver 50 are bi-directional and exclusive transmission channels. Besides, they are long-distance transmission channels.

In the above embodiment, the wireless signal transmitted by the electronic device 10 is the first wireless signal; the wireless signal transmitted by the transceiver 50 is the second wireless signal.

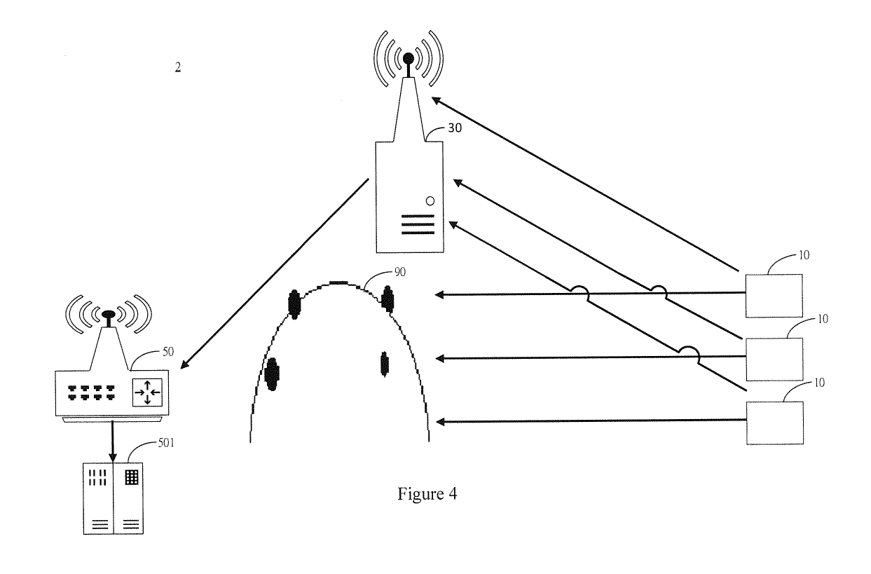

Please refer to FIG. 4. As shown in the figure, the present invention provides a wireless transmission system 2 applicable to a remote surveillance system. The wireless transmission system 2 comprises a repeater 30, a transceiver 50, and a plurality of electronic device 10. According to the present embodiment, the surveillance system is used for monitoring a fish farm. Nonetheless, it can be applied to monitoring places such as a factory or a greenhouse. According to the present embodiment, the plurality of electronic devices 10 are temperature sensors, water level sensors, pump sensors, or other electronic devices. In addition, the transceiver 50 can transmit the received wireless signal to a surveillance host 501 for providing information to the monitor staff.

The values sensed by the plurality of electronic devices 10 are transmitted to the transceiver 50 in the form of a wireless signal, which is just a sensing signal. If the wireless signal is blocked by the obstruction 90, one of the plurality of receiving channels of the repeater 30 can be used to receive the wireless signal. Then the transmitting/receiving channel of the repeater 30 transmits the wireless signal to the receiving/transmitting channel of the transceiver 50. Thereby, the transceiver still may receive the wireless signal. If a monitor staff is to control the electronic device 10, such as turn on a pump, the control signal can be transmitted wirelessly through the transceiver 50.

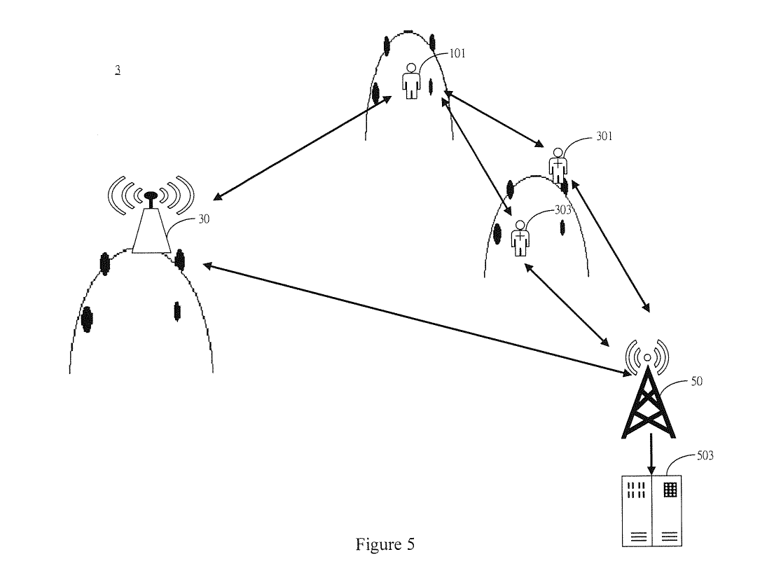

Please refer to FIG. 5. As shown in the figure, the present embodiment provides a wireless transmission system 3 applicable to mountain-area rescue. The wireless transmission system 3 comprises a repeater 30 and a transceiver 50. A victim 101 carries an electronic device capable of transmitting a mayday signal, such as a smartphone or a GPS electronic device. A plurality of rescuers 301, 303 carry portable repeaters, respectively. According to the present embodiment, the repeater 30 is a fixed repeater disposed at the height of the mountain area. In addition, the transceiver 30 is disposed in a rescue unit for receiving the mayday signal and transmitting the mayday signal to a rescue center 503.

Please refer again to FIG. 5. When the victim 101 is lost in a mountain area or a mountain accident occurs, the electronic device is used for transmitting a wireless mayday signal, which includes the current location of the electronic device. Owing to the obstruction by the mountains, communication blind spots are generated, disabling the wireless mayday signal to the transmitted smoothly to the transceiver 50. The mayday signal can be transmitted to the transceiver 50 through the repeater 30. The communication blind spots exist between the victim 10 and the transceiver 50 due to the obstruction of the mountains, the wireless mayday signal transmitted by the victim's electronic device 101 can be first received by the portable repeater carried by the plurality of rescuers 301, 302. Then the wireless mayday signal is transmitted to the transceiver 50. The transceiver 50 transmits the wireless mayday signal to the rescue center 503, which informs the plurality of rescuers 301, 303 of the location of the electronic device contained in the wireless mayday signal for rescuing the victim 101. When the rescue center 503 transmits a message to the victim 101, the message can be transmitted to the victim 101 wirelessly via the transceiver 50 and the repeater 30 or the portable repeater carried by one of the plurality of rescuers 301, 303.

In addition to the above embodiments, the present invention also can be applied to other applications such as the communication among ocean-going fleets.

Accordingly, the present invention conforms to the legal requirements owing to its novelty, nonobviousness, and utility. However, the foregoing description is only embodiments of the present invention, not used to limit the scope and range of the present invention. Those equivalent changes or modifications made according to the shape, structure, feature, or spirit described in the claims of the present invention are included in the appended claims of the present invention.

1. A wireless transmission system, comprising:
at least an electronic device, transmitting a first wireless signal;
a repeater, having a plurality of receiving channels and a transmitting/receiving channel, said plurality of receiving channels receiving said first wireless signal, said transmitting/receiving channel transmitting said first wireless signal received by said repeater; and
a transceiver, having a plurality of receiving channels for receiving said first wireless signal transmitted by said electronic device, and having a receiving/transmitting channel for receiving said first wireless signal transmitted by said transmitting/receiving channel of said repeater.

2. The wireless transmission system of claim I, wherein when said transceiver may unable to receive said first wireless signal transmitted by said electronic device correctly, said transceiver still may receive said first wireless signal via said repeater.

3. The wireless transmission system of claim 1, wherein said repeater comprises a plurality of communication chips; said plurality of communication chips comprise said plurality of receiving channels; and each of the at least on e plurality of communication chips further includes said transmitting/receiving channel.

4. The wireless transmission system of claim 1, wherein said transceiver has a transmitting channel for transmitting a second wireless signal to said electronic device; when said transmitting channel of said transceiver transmits said second wireless signal, said receiving/transmitting channel of said transceiver transmits said second wireless signal to said transmitting/receiving channel of said repeater; said repeater has a transmitting channel; said transmitting channel of said repeater transmits said received second wireless signal to said electronic device; when said electronic device is unable to receive said second wireless signal transmitted by said transceiver correctly, said electronic device still can receive said second wireless signal via said repeater.

5. The wireless transmission system of claim 4, wherein said transceiver comprises a plurality of communication chips; said plurality of communication chips comprise said plurality of receiving channels; each of the at least one plurality of communication chips further includes said transmitting channel; and each of the at least one plurality of communication chips further includes said transmitting/receiving channel.

6. The wireless transmission system of claim 1, wherein the communication protocol of said plurality of receiving channels of said repeater is different from the communication protocol of said transmitting/receiving channel of said repeater.

7. The wireless transmission system of claim 1, wherein the communication protocol of said transmitting/receiving channel of said repeater and the communication protocol of said receiving/transmitting channel of said transceiver are both the IEEE802.15.4g communication protocol.

8. The wireless transmission system of claim 1, wherein the bandwidth of said transmitting/receiving channel of said repeater is wider than the bandwidth of said plurality of receiving channels of said repeater.
